(19) United States
(12) Patent Application Publication
(10) Pub. No.: US 2026/0279941 A1
(43) Pub. Date: Sep. 17, 2026

(54) BIPOLAR ELECTRODE RECYCLING METHOD

(71) Applicant: TOYOTA JIDOSHA KABUSHIK KAISHA, Toyota-shi (JP)

(72) Inventor: Tomohiro YOKOYAMA, Toyota-shi (JP)

(73) Assignee: TOYOTA JIDOSHA KABUSHIK KAISHA, Toyota-shi (JP)

(21) Appl. No.: 19/434,853

(22) Filed: Dec. 29, 2025

(30) Foreign Application Priority Data
Mar. 13, 2025 (JP) 2025-040219

(51) Int. Cl. H01M 10/54; C22B 7/00; H01M 10/0525

(52) U.S. Cl. CPC H01M 10/54; C22B 7/005; H01M 10/0525

(57) ABSTRACT

A bipolar electrode recycling method includes ultrasonic stripping of each of a current collector, a first electrode active material layer, and a second electrode active material layer, of a bipolar electrode, using ultrasonic waves from an ultrasonic horn, in which the ultrasonic stripping includes bringing an emission face of the ultrasonic horn that emits ultrasonic waves into contact with the bipolar electrode, and applying vibrations to the bipolar electrode in a thickness direction of the bipolar electrode, and bringing the emission face of the ultrasonic horn that emits ultrasonic waves into contact with a side face of the second electrode active material layer, and applying vibrations to the second electrode active material layer in a direction along the other face of the current collector.

### CROSS-REFERENCE TO RELATED APPLICATION

This application claims priority to Japanese Patent Application No. 2025-040219 filed on March 13, 2025. The disclosure of the above-identified application, including the specification, drawings, and claims, is incorporated by reference herein in its entirety.

### BACKGROUND

### 1. Technical Field

The present disclosure relates to a bipolar electrode recycling method.

### 2. Description of Related Art

Japanese Unexamined Patent Application Publication No. 2022-147473 (JP 2022-147473 A) discloses technology for separating a bipolar electrode into a cathode current collector and an anode current collector, and an adhesive and a substrate, by placing a sharp end portion of a removal tool against a boundary between the cathode current collector and the adhesive or a boundary between the anode current collector and the adhesive, and sliding the tool.

### SUMMARY

However, in JP 2022-147473 A, there is a problem in that a removal tool is required, and moreover the removal tool itself is subjected to wear, causing material thereof to be mixed into the composite material that is recovered, thereby reducing the quality of the recycled active material.

The present disclosure has been made in view of the above, and an object thereof is to provide a bipolar electrode recycling method that can suppress reduction in the quality of recycled active material when the bipolar electrode is recycled.

A bipolar electrode recycling method according to the present disclosure includes ultrasonic stripping, with respect to a bipolar electrode including a current collector, a first electrode active material layer attached to one face of the current collector, and a second electrode active material layer attached to another face of the current collector and of which a Young's modulus is greater than that of the first electrode active material layer, of stripping off each of the current collector, the first electrode active material layer, and the second electrode active material layer, using ultrasonic waves from an ultrasonic horn, in which the ultrasonic stripping includes bringing an emission face of the ultrasonic horn that emits ultrasonic waves into contact with the bipolar electrode, and applying vibrations to the bipolar electrode in a thickness direction of the bipolar electrode, and bringing the emission face of the ultrasonic horn that emits ultrasonic waves into contact with a side face of the second electrode active material layer, and applying vibrations to the second electrode active material layer in a direction along the other face of the current collector.

According to the present disclosure, an advantage is yielded in that reduction in quality of the recycled active material can be suppressed when the bipolar electrode is regenerated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a flowchart showing an overview of a bipolar electrode recycling method according to a first embodiment of the present disclosure;

FIG. 2 is a diagram illustrating a schematic configuration of an ultrasonic stripping device according to the first embodiment of the present disclosure;

FIG. 3 is a diagram illustrating an overview of the bipolar electrode recycling method using the ultrasonic stripping device according to the first embodiment of the present disclosure;

FIG. 4 is a diagram illustrating a schematic configuration of an ultrasonic stripping device according to a second embodiment of the present disclosure; and

FIG. 5 is a diagram illustrating an overview of a bipolar electrode recycling method using the ultrasonic stripping device according to the second embodiment of the present disclosure;

### DETAILED DESCRIPTION OF EMBODIMENTS

A bipolar electrode recycling method according to an embodiment of the present disclosure will be described below with reference to the drawings. Also, the drawings referred to in the following description merely schematically illustrate shapes, sizes, and positional relation, to the extent that contents of the present disclosure can be understood. That is to say, the present disclosure is not limited to just the shapes, sizes, and positional relations exemplified in the drawings. Furthermore, in the drawings, the same parts are denoted by the same signs.

### First Embodiment

### Overview of Bipolar Electrode Recycling Method

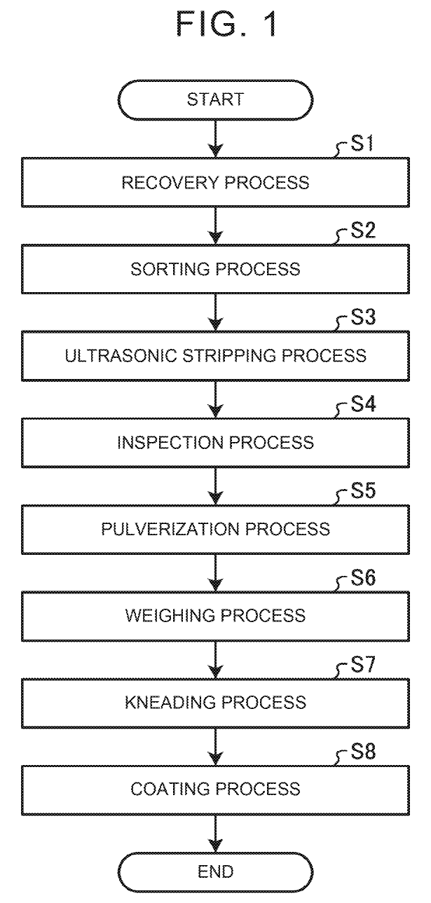

First, the bipolar electrode recycling method will be described. FIG. 1 is a flowchart showing an overview of the bipolar electrode recycling method. The bipolar electrode recycling method shown in FIG. 1 is a direct recycling (reuse) technique for recycling lithium-ion batteries, in which technique the active material is recycled without being returned to its raw material state, by separating a bipolar electrode coating from a current collector foil. Specifically, the method for separating the bipolar electrode coating from the current collector foil will be described as a low-cost, highly efficient technology for recovering the bipolar electrode coating from high-capacity batteries (with coating weight of PHV or higher) in which the bipolar electrode coating is thick and difference between the composite material and the current collector foil readily occurs due to ultrasonic amplitude. The bipolar electrode coating recovered by the bipolar electrode recycling method according to the present disclosure presumes that only either a cathode or an anode will be recovered, and that recycled composite material will be used alone or mixed with new active material. That is to say, the bipolar electrode coating recovered by the bipolar electrode recycling method of the present disclosure is for process scraps, and accordingly can be treated as a direct recycling product equivalent to new active material, since there are no composition defects such as lithium (Li) loss from the active material.

As shown in FIG. 1, first, a worker performs a recovery process to recover unrecoverable process scraps from bipolar electrodes to be recycled (step S1), and then performs a sorting process to separate the bipolar electrodes from workpieces (step S2).

Next, the worker performs an ultrasonic stripping process of recovering bipolar electrode composite material from the bipolar electrode using an ultrasonic stripping device (step S3). Note that the ultrasonic stripping process will be described in detail later.

Thereafter, the worker performs an inspection process to inspect whether any metallic foreign matter, from an ultrasonic horn of the ultrasonic stripping device or current collector foil pieces of the bipolar electrode, or the like, has become intermingled (step S4). In this case, the worker evaluates the physical properties of the composite material that is recovered (e.g., composition ICP/TC) and determines a blending ratio that will satisfy acceptance criteria for new active materials.

Next, the worker adds an intended solvent (of composition and amount used in kneading process) to the coating composite material that is recovered, and performs a pulverization process in which the mixture is pulverized using a ball mill or the like (step S4).

Thereafter, the worker performs a weighing process of weighing and mixing new active material and the directly recycled product obtained through the above processes (step S5).

Next, the worker performs the kneading process to produce a coating paste according to the same standards as in normal manufacturing methods (step S6), and then performs a coating process to apply the coating paste to a new workpiece (step S7), thereby completing this process.

In this way, the method for separating the bipolar electrode coating from the current collector foil will be described as a low-cost, highly efficient technology for recovering the bipolar electrode coating from high-capacity batteries (with coating weight of PHV or higher) in which the bipolar electrode coating is thick and difference between the composite material and the current collector foil readily occurs due to ultrasonic amplitude. In the bipolar electrode recycling method according to the present disclosure, ultrasonic wave irradiation is performed by an ultrasonic horn, which will be described later, perpendicularly to the coating of the bipolar electrode, such that the cathode composite material is not stripped, and only the anode composite material is stripped off. Thereafter, in the bipolar electrode recycling method according to the present disclosure, the cathode composite material is stripped by irradiating the bipolar electrode from which the anode composite material has been stripped off, by an ultrasonic horn, either from a horizontal direction, or at a low angle. Note that in the bipolar electrode recycling method according to the present disclosure, a single-sided cathode following stripping the anode composite material can be stripped off using the same method as for normal non-bipolar cathode composite material (heating, crushing, and stripping, or dissolving the current collector foil by chemicals). The bipolar electrode coating recovered by the bipolar electrode recycling method according to the present disclosure is for process scraps, and accordingly can be treated as a direct recycling product equivalent to new active material, since there are no composition defects, such as lithium (Li) loss from the active material, or the like. Further, the recovered coating after ultrasonic stripping is not pulverized, and accordingly the kneading process, or the pulverizing process that is a process preceding the kneading step is necessary. Furthermore, battery active materials for high capacity have a broad particle size distribution to begin with, and a thick coating weight, and accordingly even when there are some aggregates in the direct recycled product, this will not affect the coating performance.

### Details of Ultrasonic Stripping Device and Ultrasonic Stripping Process

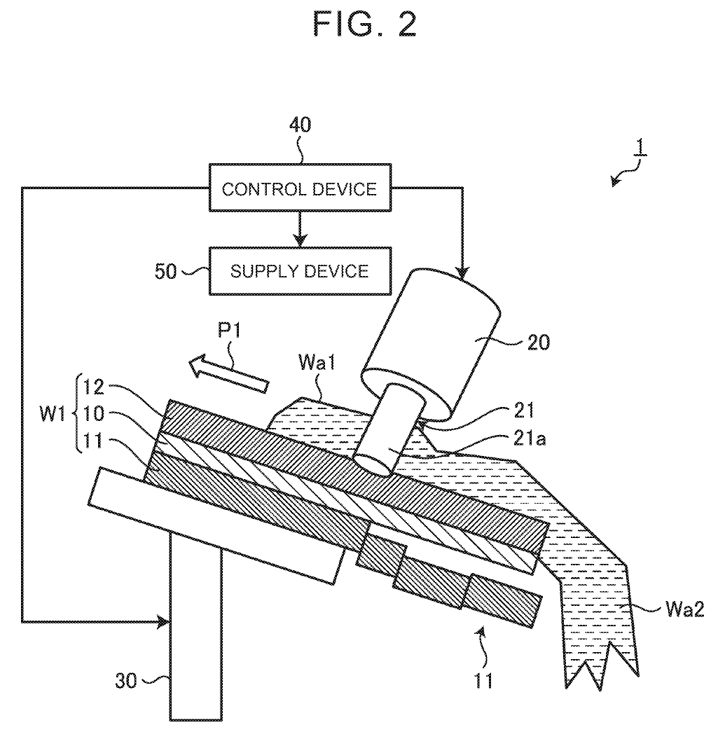

Next, an overview of the ultrasonic stripping device will be described, following which the ultrasonic stripping process using the ultrasonic stripping device will be described in detail. FIG. 2 is a diagram illustrating a schematic configuration of the ultrasonic stripping device.

An ultrasonic stripping device 1 illustrated in FIG. 2 includes an ultrasonic probe 20, a conveying device 30 that conveys a bipolar electrode W1, a control device 40, and a supply device 50 that supplies water toward the bipolar electrode W1.

The bipolar electrode W1 includes a current collector foil 10 that is a current collector, a first electrode active material layer 11 (anode composite material) that is attached to one side of the current collector foil 10, and a second electrode active material layer 12 (cathode composite material) that is attached to the other side of the current collector foil 10, and that has a Young's modulus greater than that of the first electrode active material layer 11. The first electrode active material layer 11 (anode composite material) is, for example, carbon, and the second electrode active material layer 12 (cathode composite material) is, for example, inorganic ceramic or the like.

The ultrasonic probe 20 has an ultrasonic horn 21 at a distal end thereof, and is provided so as to be movable along a conveying direction P1. The ultrasonic probe 20 is configured using a movable drive mechanism such as an arm, an ultrasonic oscillator, a vibrator, or the like, and transmits ultrasonic vibrations to the ultrasonic horn 21. The ultrasonic probe 20 vibrates the ultrasonic horn 21 at an amplitude of 10 μm or more (frequency of 40 kHz), and more preferably at an amplitude of 20 μm or more (frequency of 20 kHz or less). The ultrasonic horn 21 is covered with a resin material 21a so as to cover the entire surface, including an emission face that emits ultrasonic waves. The resin material 21a covers the ultrasonic horn 21 to suppress deformation and wear. That is to say, the resin material 21a suppresses contamination by metallic foreign matter due to wear of the ultrasonic horn 21. The resin material 21a that is used is, for example, a PEEK material having an elongation rate of 20% or less and a Rockwell hardness of 120 or higher. The thickness of the resin material 21a covering the ultrasonic horn 21 is preferably 10 mm or less, more preferably 1 mm or less, such that the ultrasonic horn can conform to the vibrations of the ultrasonic source and perform transmission thereof to the bipolar electrode W1 without deviation. Note that the resin material 21a does not need to cover the ultrasonic horn 21, and may be a resin sheet or the like.

The conveying device 30 conveys the bipolar electrode W1 with the bipolar electrode W1 fixed inclined at a predetermined angle. The conveying device 30 is configured using a winding device or the like.

The control device 40 is realized using a processor, which is a processing device having hardware such as a field-programmable gate array (FPGA), a central processing unit (CPU), or the like, and memory that is a temporary storage area used by the processor. The control device 40 centrally controls the operations of each part of the ultrasonic stripping device 1 in accordance with a program recorded in the memory.

The supply device 50, under the control of the control device 40, supplies water Wa1 to the bipolar electrode W1 to wet or to clean the surface of the bipolar electrode W1.

### Details of Ultrasonic Stripping Process

Next, the ultrasonic stripping process will be described in detail. As illustrated in FIG. 2, first, in the ultrasonic stripping process, the conveying device 30 conveys the bipolar electrode W1 in the conveying direction P1 under the control of the control device 40, while the supply device 50 supplies water Wa1 to the bipolar electrode W1 under control of the control device 40. In the ultrasonic stripping process, under control of the control device 40, the ultrasonic probe 20 then emits ultrasonic waves from a vertical direction of the second electrode active material layer 12 on the bipolar electrode W1, in a state with the emission face of the ultrasonic horn 21 in contact with and against the entire bipolar electrode W1. Specifically, in the ultrasonic stripping process, the emission face (output face) of the ultrasonic horn 21 is brought into contact with the entire bipolar electrode W1 at an angle of 30° or more, preferably 60° or more, and more preferably close to 90° with respect to the vertical direction of the second electrode active material layer 12 in the bipolar electrode W1, and the hardness of the second electrode active material layer 12, which is the cathode composite material, is utilized to crack and strip off the first electrode active material layer 11. In this case, the vibrations of the second electrode active material layer 12 is transmitted to the first electrode active material layer 11, which is the anode composite material on the rear side of the bipolar electrode W1, by the ultrasonic waves of the ultrasonic horn 21, and the first electrode active material layer 11 is stripped off from the current collector foil 10. Specifically, the Young's modulus of the first electrode active material layer 11 is smaller than that of the second electrode active material layer 12, i.e., it is softer than the second electrode active material layer 12, and accordingly is unable to conform to the amplitude of the current collector foil 10, resulting in surface delamination. On the other hand, the second electrode active material layer 12 has a larger Young's modulus than that of the first electrode active material layer 11, i.e., is harder than the first electrode active material layer 11, and therefore oscillates conforming to the amplitude of the current collector foil 10 and does not strip off from the current collector foil 10 under vertical direction vibrations. As a result, the first electrode active material layer 11 slides off in clumps due to the adhesiveness within the anode composite material, following complete detachment. Furthermore, the water Wa2 is recovered as a slurry containing the first electrode active material layer 11.

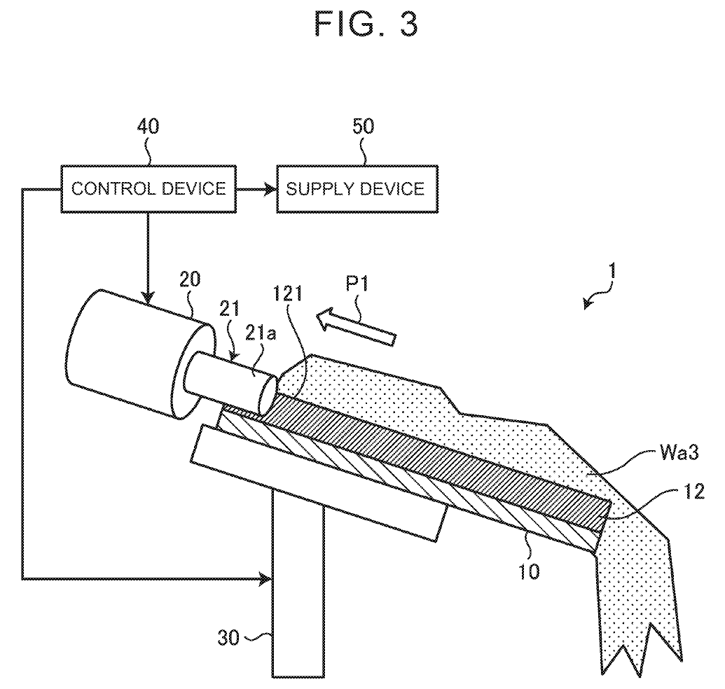

Next, as illustrated in FIG. 3, in the ultrasonic stripping process, the supply device 50 supplies water Wa1 to the bipolar electrode W1 under the control of the control device 40, and the ultrasonic probe 20 moves under the control of the control device 40, bringing the ultrasonic emission face of the ultrasonic horn 21 that emits ultrasonic waves into contact with a side face 121 (end face) of the second electrode active material layer 12, and applying vibrations to the second electrode active material layer 12 in a direction along the other face of the current collector foil 10. In this case, the second electrode active material layer 12 is stripped off from the current collector foil 10 and dissolved in the water Wa1, and is recovered in the form of a slurry. At this time, in the ultrasonic stripping process, the control device 40 may perform emission of ultrasonic waves by placing the ultrasonic probe 20 so as not to strike an end portion of the bipolar electrode W1, as this is a starting point for collapse of the current collector foil 10.

According to the first embodiment described above, the emission face of the ultrasonic horn 21 that emits ultrasonic waves is brought into contact with the bipolar electrode W1, and vibrations in a thickness direction of the bipolar electrode are applied to the bipolar electrode W1 to strip off the first electrode active material layer 11, following which the emission face of the ultrasonic horn 21 that emits ultrasonic waves is brought into contact with the side face 121 of the second electrode active material layer 12, and vibrations in a direction along the other face of the current collector foil 10, which is the current collector, are applied to the second electrode active material layer 12 to strip off the second electrode active material layer 12, such that reduction of quality of the recycled active material can be suppressed when the bipolar electrode W1 is recycled.

Also, according to the first embodiment, the ultrasonic horn 21 is coated with the resin material 21a so as to cover the entire surface, including the emission face that emits ultrasonic waves, and accordingly, the ultrasonic horn 21 can be suppressed from being deformed or worn, and also the ultrasonic horn 21 can be suppressed from contamination by metal foreign matter due to wear thereof.

Note that while in the first embodiment, the bipolar electrode W1 is used, the present disclosure can also be applied to a laminated battery cell, in which case, in the ultrasonic stripping process, the laminated cell before disassembly is irradiated by ultrasonic waves, using the electrolytic solution with which the laminated cell is filled as a vibration medium, and just the anode composite material can be stripped off.

### Second Embodiment

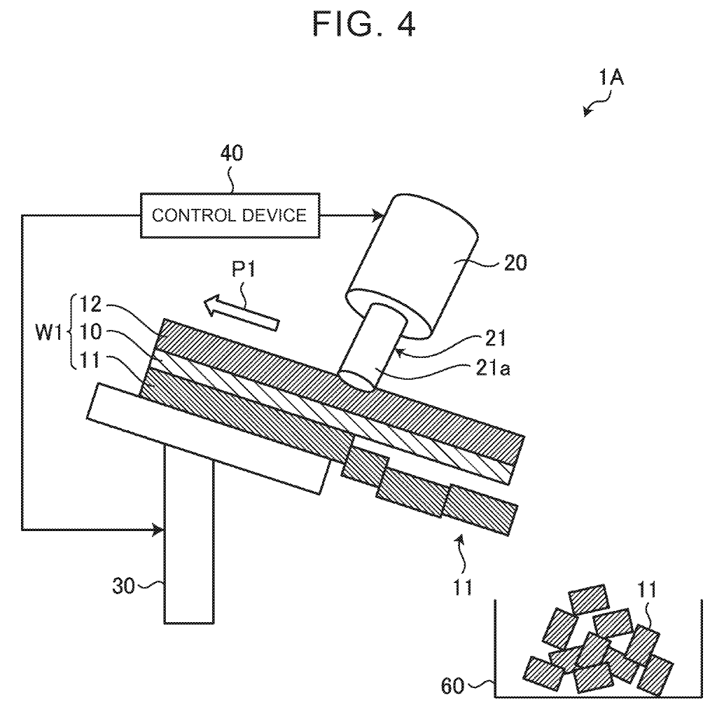

Next, a second embodiment will be described. FIG. 4 is a diagram illustrating a schematic configuration of an ultrasonic stripping device according to the second embodiment.

An ultrasonic stripping device 1A illustrated in FIG. 4 has the same configuration as that of the ultrasonic stripping device 1, except that the supply device 50 that supplies water, described above, is omitted. That is to say, the ultrasonic stripping device 1A strips off the first electrode active material layer 11 and the second electrode active material layer 12 from the bipolar electrode W1 using ultrasonic waves from the ultrasonic horn 21 without using water.

### Details of Ultrasonic Stripping Process

Next, the ultrasonic stripping process will be described in detail. As illustrated in FIG. 4, in the ultrasonic stripping process, under the control of the control device 40, the ultrasonic probe 20 emits ultrasonic waves from the vertical direction of the second electrode active material layer 12 on the bipolar electrode W1, in a state in which the emission face of the ultrasonic horn 21 is in contact with and against the entire bipolar electrode W1, while the bipolar electrode W1 is being conveyed in the conveying direction P1 by the conveying device 30 under the control of the control device 40.

In this case, the vibrations of the second electrode active material layer 12 are transmitted to the first electrode active material layer 11, which is the anode composite material on the rear side of the bipolar electrode W1, by the ultrasonic waves of the ultrasonic horn 21, causing the first electrode active material layer 11 to be stripped off from the current collector foil 10, and the first electrode active material layer 11 is recovered by a recovery device 60.

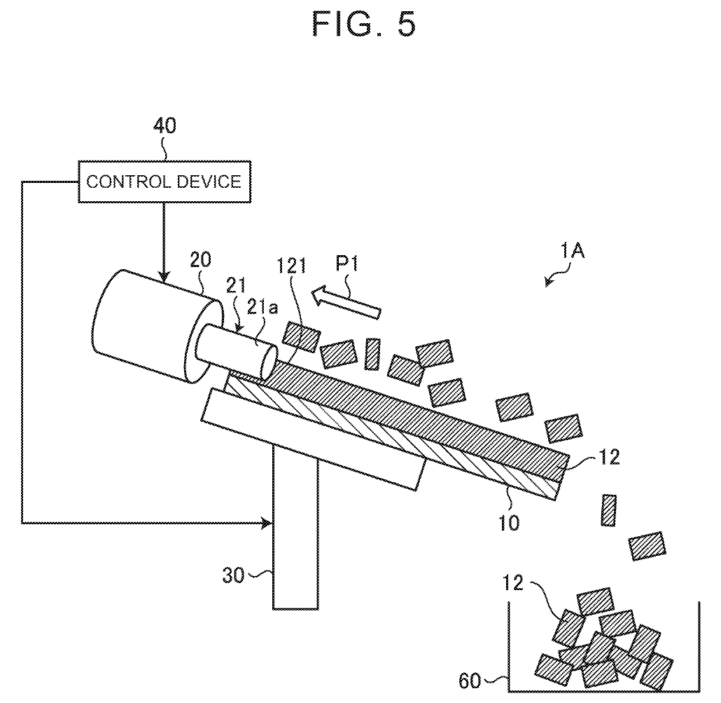

Next, as illustrated in FIG. 5, in the ultrasonic stripping process, the ultrasonic probe 20 moves under the control of the control device 40, bringing the emission face of the ultrasonic horn 21 that emits ultrasonic waves into contact with the side face 121 (end face) of the second electrode active material layer 12, and applying vibrations to the second electrode active material layer 12 in a direction along the other face of the current collector foil 10. In this case, the second electrode active material layer 12 is stripped off from the current collector foil 10 and recovered by the recovery device 60.

According to the second embodiment described above, each of the first electrode active material layer 11 and the second electrode active material layer 12 can be stripped off from the current collector foil 10 without using water, which does away with the need for a drying step for drying each of the first electrode active material layer 11 and the second electrode active material layer 12, thereby reducing the number of processes.

Also, according to the second embodiment, the ultrasonic horn 21 is coated with resin material 21a so as to cover the entire surface thereof, including the emission face that emits ultrasonic waves, and accordingly, the ultrasonic horn 21 can be suppressed from being deformed or worn, and also the ultrasonic horn 21 can be suppressed from contamination by metal foreign matter due to wear thereof.

Also, according to the first embodiment, adhesive properties of each of the first electrode active material layer 11 and the second electrode active material layer 12 remain, and thus can be recovered in flake form without being pulverized, and scattering loss of each of the first electrode active material layer 11 and the second electrode active material layer 12, which are coating composite materials, can be reduced.

Further effects and modifications can be readily derived by those skilled in the art. Broader aspects of the present disclosure are not limited to the specific details and representative embodiments shown and described above. Accordingly, various modifications may be made without departing from the spirit or scope of the general inventive concept defined by the appended claims and their equivalents.

Although some embodiments of the present application have been described in detail above with reference to the drawings, these are merely exemplary, and the present disclosure can be implemented in other forms subjected to various modifications and improvements based on the knowledge of those skilled in the art, including the aspects described in the disclosure of the present disclosure.

What is claimed is:

1. A bipolar electrode recycling method comprising:
ultrasonic stripping, with respect to a bipolar electrode including a current collector, a first electrode active material layer attached to one face of the current collector, and a second electrode active material layer attached to another face of the current collector and of which a Young's modulus is greater than that of the first electrode active material layer, of stripping off each of the current collector, the first electrode active material layer, and the second electrode active material layer, using ultrasonic waves from an ultrasonic horn, wherein
the ultrasonic stripping includes
bringing an emission face of the ultrasonic horn that emits ultrasonic waves into contact with the bipolar electrode, and applying vibrations to the bipolar electrode in a thickness direction of the bipolar electrode, and
bringing the emission face of the ultrasonic horn that emits ultrasonic waves into contact with a side face of the second electrode active material layer, and applying vibrations to the second electrode active material layer in a direction along the other face of the current collector.

2. A bipolar electrode recycling method according to claim 1, wherein a surface of the ultrasonic horn, including the emission face that emits the ultrasonic waves, is coated with a resin material.
